(19) United States
(12) Patent Application Publication
(10) Pub. No.: US 2004/0088092 A1
(43) Pub. Date: May 6, 2004

(54) Audio-visual system for vehicle use

(76) Inventors: Yu-Hsin Chen, Taichung City (TW); Chi-Chang Liu, Taichung Hsien (TW); Meng-Chang Lin, Taichung City (TW)

Correspondence Address: TROP PRUNER & HU, PC, 8554 KATY FREEWAY, SUITE 100, HOUSTON, TX, 77024, US

(21) Appl. No.: 10/331,690

(22) Filed: Dec. 30, 2002

(30) Foreign Application Priority Data
Nov. 1, 2002 (TW) 091217583

(51) Int. Cl. G06F 17/00

(52) U.S. Cl. 701/36; 307/10.1

(57) ABSTRACT

An audio-visual system includes a signal source, a distributor, a control box, a control panel, and a sound reproducing unit. The signal source provides at least an audio source signal. The distributor includes a pre-amplifier coupled electrically to the signal source for amplifying the audio source signal therefrom, and an impedance matching circuit coupled electrically to the pre-amplifier for matching load impedance associated with an amplified audio source signal from the pre-amplifier to that of the signal source. The control box is coupled electrically to the distributor for processing and amplifying an impedance-matched signal received therefrom. The control panel is coupled electrically to the control box for receiving output of the control box. The sound reproducing unit is coupled electrically to the control panel for audio reproduction.

### BACKGROUND OF THE INVENTION

1. Field of the Invention

The invention relates to an audio-visual system for vehicle use, more particularly to an audio-visual system that can minimize the effects of signal interference and noise attributed to long distance transmission.

2. Description of the Related Art

As shown in FIG. 1, a conventional audio-visual system 1 commonly installed in passenger buses is shown to include a signal source 11, a processing unit 12, a plurality of control panels 13 mounted on seats of the passenger bus, and a plurality of speakers 14 plugged into the control panels 13, respectively.

The signal source 11 includes a plurality of input terminals for receiving different audio-visual signals, such as those from tapes, compact discs, radio, etc.

The processing unit 12 is responsible for processing the audio-visual signals from the signal source 11.

Each control panel 13 has a respective wired connection with the processing unit 12, and is provided with control buttons to be operated by passengers for channel selection, volume adjustment, etc. of the audio-visual signals.

During operation, the processing unit 12 distributes the audio-visual signals from the signal source 11 to each of the control panels 13. By operating the control buttons on the control panel 13, a passenger can select a desired audio-visual signal from the signal source 11. The audio part of the audio-visual signal is then reproduced by the corresponding speaker 14. In the conventional audio-visual system 1, signals from the processing unit 12 are transmitted to the control panels 13 through electrical wires in an analog format. As such, although the purpose of signal transmission is attained, since long distance signal transmission to the control panels 13 is accomplished through electrical wires, the signals that reach the control panels 13 are undesirably attenuated or distorted. The system 1 is also susceptible to noise attributed to ambient interference. Accordingly, the quality of sound reproduced by the speakers 14 is poor.

Since signals are susceptible to interference and are attenuated or distorted when transmitted in the analog format, another conventional audio-visual system 2 having signals transmitted in a digital format has been proposed heretofore, as shown in FIG. 2. The audio-visual system 2 includes a signal source 21, a processing unit 22, a plurality of receivers 23 to be mounted on seats of a passenger bus, and a plurality of speaker 24 plugged into the receivers 23, respectively.

The signal source 21 provides different audio-visual signals, such as tape-recorded programs, compact disc-recorded programs, broadcast programs, etc. The processing unit 22 includes a pre-amplifier 221 for receiving and amplifying audio signals from the signal source 21, an analog-to-digital (A/D) converter 222 for converting amplified audio signals from the pre-amplifier 221 to digital form, a microprocessor 223 for performing multiplex control processing upon the digital audio output of the A/D converter 222, a digital-to-analog (D/A) converter 224 for converting the digital processed output of the microprocessor 223 to analog form, and a post-amplifier 225 for amplifying the analog processed output of the D/A converter 224. Due to the multiplexing operation of the processing unit 22, different audio signals in different channels can be transmitted through signal transmission wires.

Each receiver 23 includes a pre-amplifier 231 for receiving and amplifying signals received from the processing unit 22, an A/D converter 232 for converting the amplified output of the pre-amplifier 231 to digital form, a microprocessor 233, a user interface 234 for channel selection and display, and an audio amplifier In the conventional audio-visual system 2, in order to transmit audio signals in the digital format, converters 222, 224 and a microprocessor 223 are required in the processing unit 22, which results in increased manufacturing costs. Moreover, while transmission in the digital format can reduce susceptibility to electromagnetic interference, the need for repeated conversion from analog to digital and from digital to analog results in signal distortion such that the quality of sound reproduced by the speakers 24 is still unsatisfactory.

### SUMMARY OF THE INVENTION

Therefore, the object of the present invention is to provide an audio-visual system suitable for vehicle use and capable of preserving the quality of original audio signals after long-distance wired transmission.

Accordingly, an audio-visual system of this invention comprises:

a plurality of signal sources, each of which provides at least an audio source signal;

a distributor including a plurality of pre-amplifiers, each of which is coupled electrically to a respective one of the signal sources for amplifying the audio source signal therefrom, the distributor further including an impedance matching circuit coupled electrically to the pre-amplifiers for matching load impedance associated with an amplified audio source signal from each of the pre-amplifiers to that of the signal sources;

a plurality of control boxes, each of which is coupled electrically to the distributor for processing and amplifying an impedance-matched signal received therefrom;

a plurality of control panels coupled electrically and respectively to the control boxes for receiving output of the respective one of the control boxes, each of the control panels being manually operable so as to generate at least one of channel selection, volume and tone control signals provided to the respective one of the control boxes; and

a plurality of sound reproducing units, each of which is coupled electrically to a respective one of the control panels for audio reproduction.

Each of the control boxes includes an audio signal processor coupled electrically to the distributor, a microprocessor, and an amplifier coupled electrically to the audio signal processor and the respective one of the control panels. The microprocessor is coupled electrically to the audio signal processor and the respective one of the control panels, and controls the audio signal processor in response to the control signal received from the respective one of the control panels for processing the impedance-matched signal received from the distributor accordingly.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a conventional audio-visual system for vehicle use;

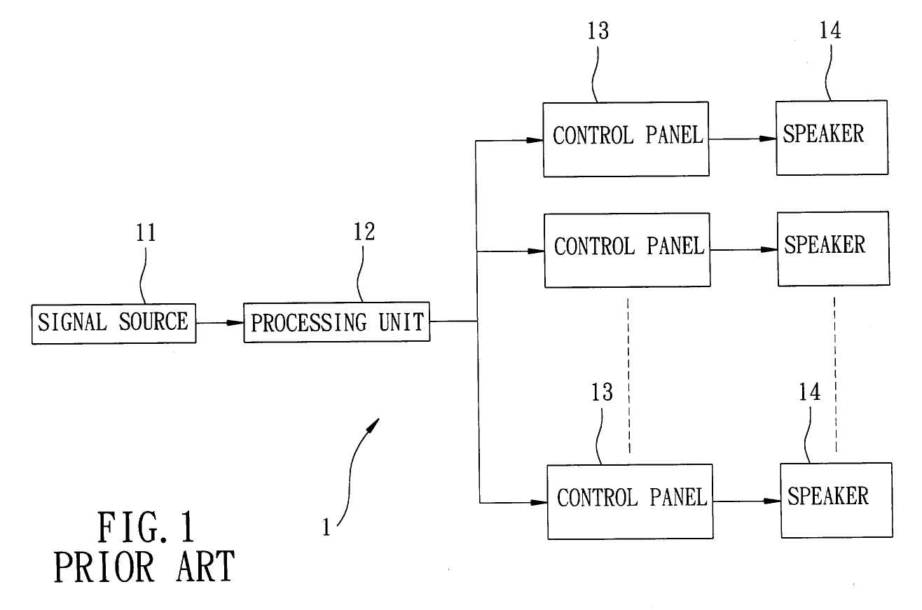

FIG. 2 is a schematic block diagram of another conventional audio-visual system for vehicle use;

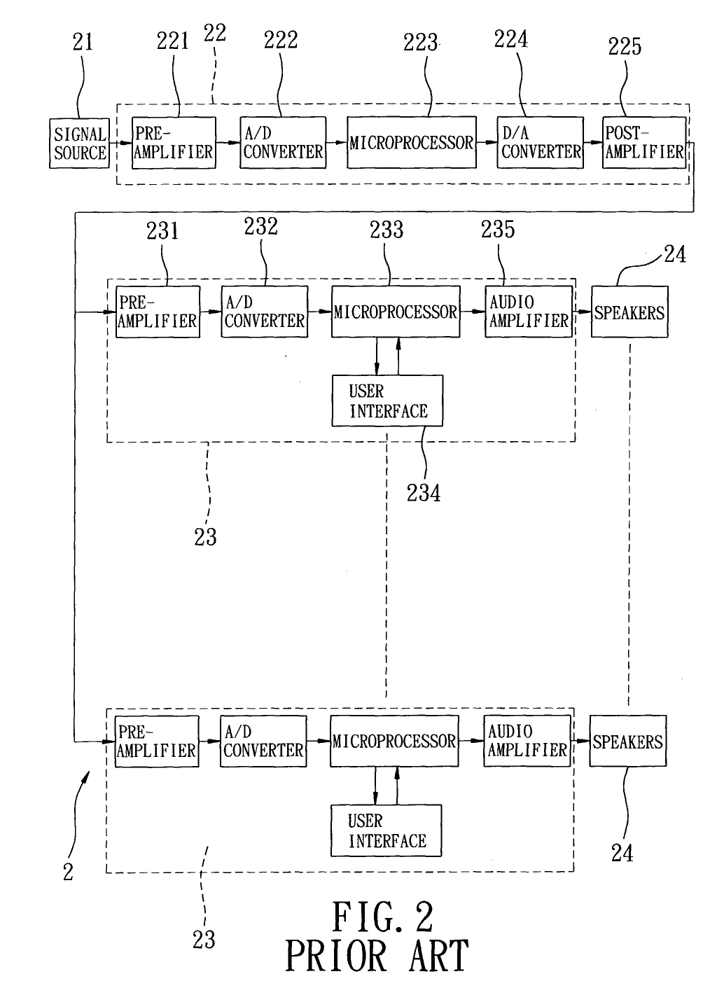

FIG. 3 is a schematic block diagram of the preferred embodiment of an audio-visual system for vehicle use according to the present invention;

FIG. 4 is a schematic block diagram to illustrate a processing flow of the preferred embodiment;

FIG. 5 is a schematic block diagram showing a distributor and a signal source of the preferred embodiment; and

FIG. 6 is a schematic block diagram showing a control panel of the preferred embodiment

### DETAILED DESCRIPTION OF THE PREFERRED EMBODIMENT

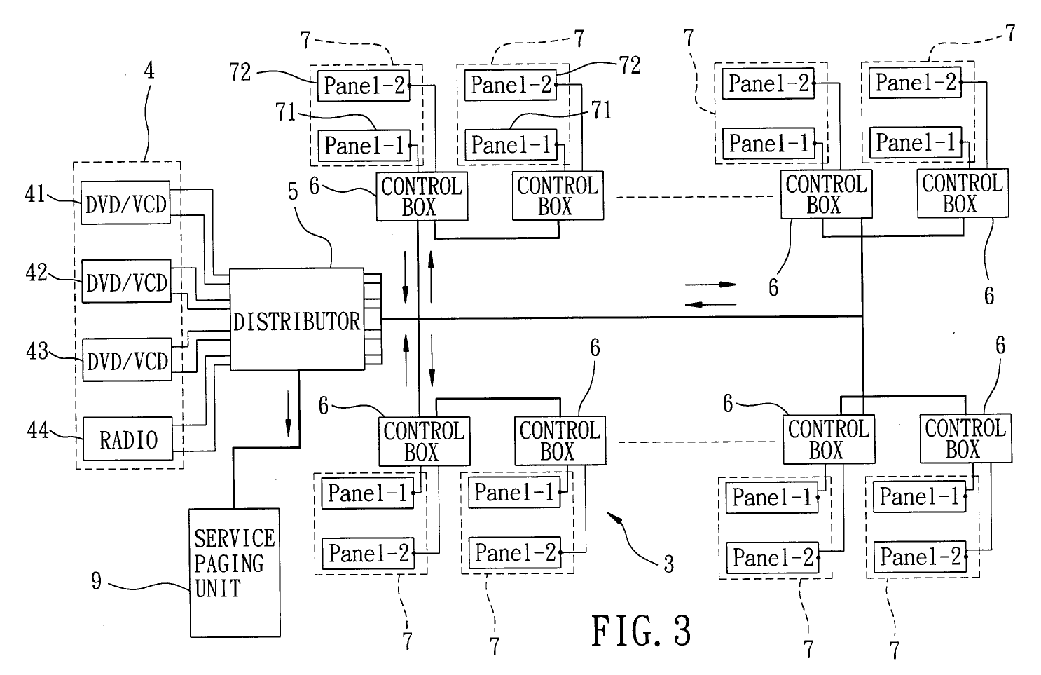

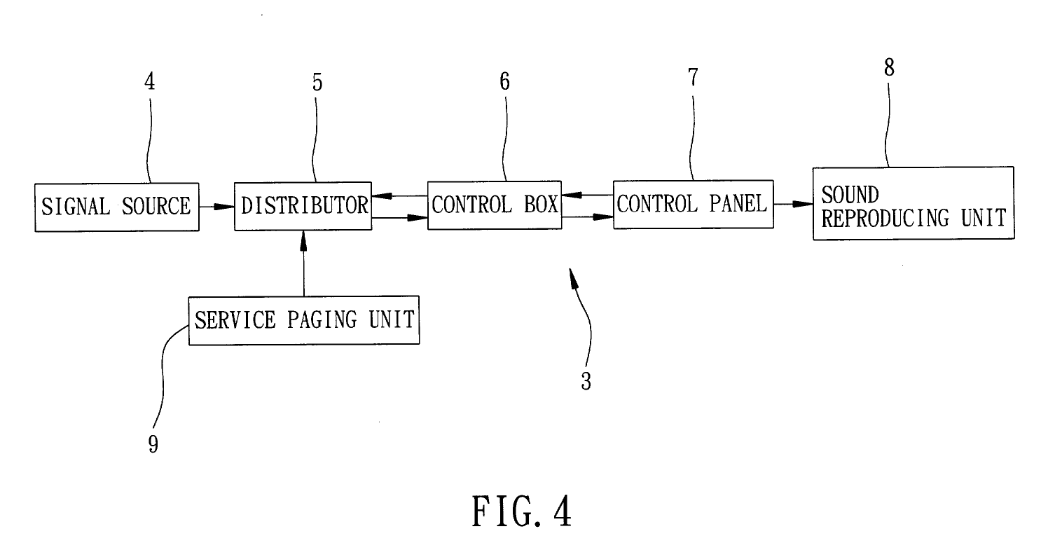

Referring to FIGS. 3 and 4, the preferred embodiment of an audio-visual system 3 according to the present invention is adapted to be installed in a vehicle, such as a passenger bus, a passenger train, a recreational vehicle, etc. The audio-visual system 3 includes a signal source 4, a distributor 5, a plurality of control boxes 6, a plurality of control panels 7, a plurality of sound reproducing units 8 (such as earphones or speakers) and a service paging unit 9.

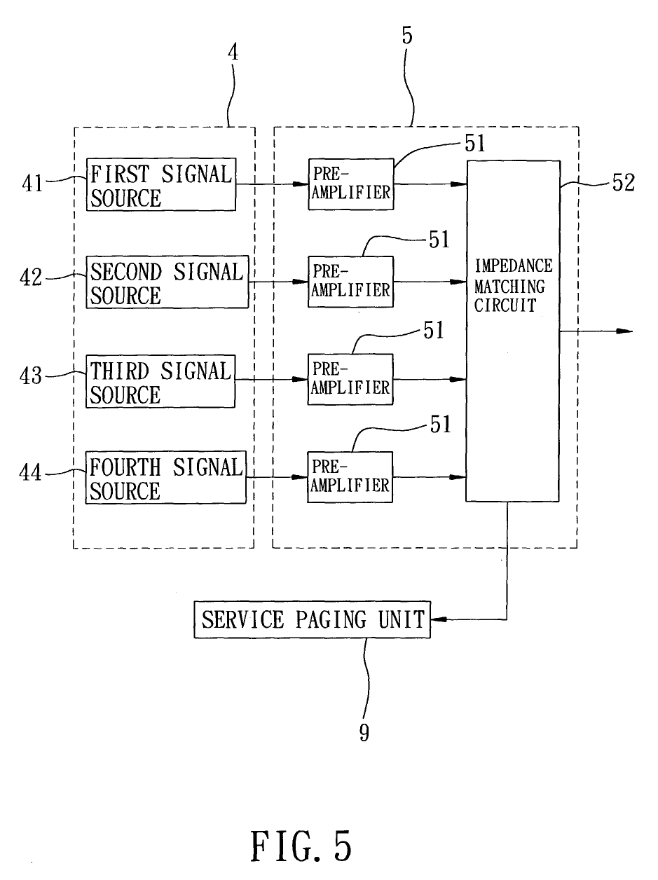

Referring further to FIG. 5, the signal source 4 is adapted to be installed at the vicinity of the driver's seat, and includes a first signal source 41, a second signal source 42, a third signal source 43, and a fourth signal source 44. In this embodiment, the first, second and third signal sources 41, 42, 43 are DVD/VCD players, while the fourth signal source 44 is a radio tuner. In practice, the signal sources may further include a GSM system, a digital TV, a GPS TV, a TV game, a personal computer, etc. By providing a plurality of the signal sources 41, 42, 43, 44, different audio-visual signals are available for passenger selection. When visual signals are to be outputted, display apparatus must be used (not shown in the Figures). Since the present invention is directed primarily to the improvement of audio signal quality, processing of visual signals will not be described herein for the sake of brevity.

The distributor 5 includes four pre-amplifiers 51 coupled electrically and respectively to the signal sources 41, 42, 43, 44 for amplifying a corresponding audio source signal therefrom, and an impedance matching circuit 52 coupled electrically to the pre-amplifiers 51 for matching load impedance associated with an amplified audio source signal from each of the pre-amplifiers 51 to that of the signal sources 41, 42, 43, 44.

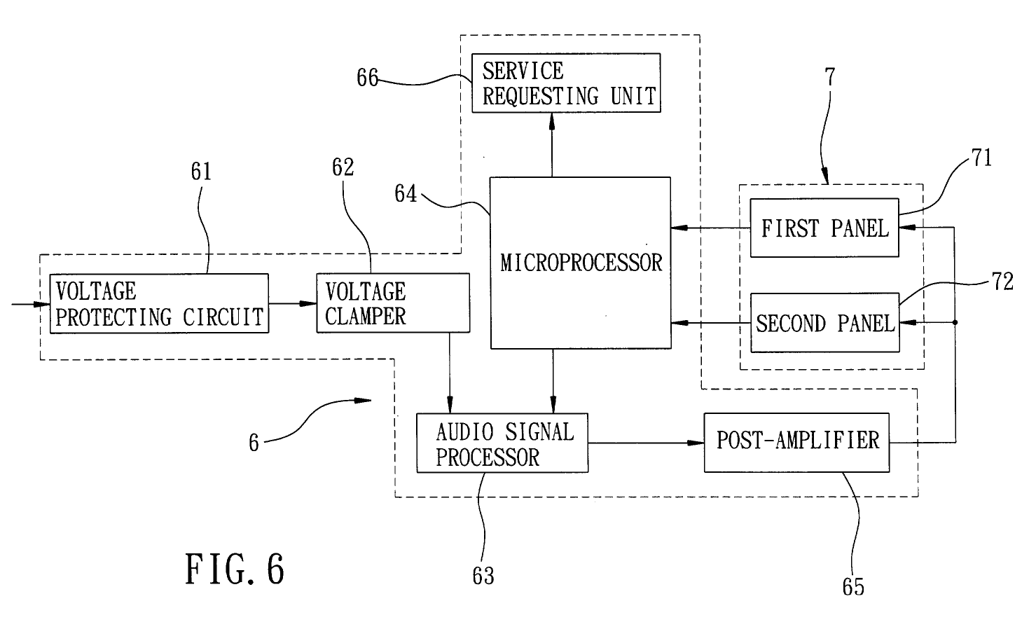

Referring to FIGS. 3 and 6, each control box 6 is coupled electrically to the output end of the distributor 5, and is preferably mounted under a passenger seat. Each control box 6 includes a voltage protecting circuit 61 coupled electrically to the distributor 5 for preventing damage due to a reverse polarity input from the distributor 5, a voltage damper 62 coupled electrically to the voltage protecting circuit 61 for blocking voltage surge that can damage components of the control box 6, an audio signal processor 63 coupled electrically to the voltage damper 62 for processing the impedance-matched signal received from the distributor 5, a microprocessor 64 coupled electrically to the audio signal processor 63 for controlling processing operation of the audio signal processor 63 in response to a control signal received thereby (to be described in greater detail hereinafter), a post-amplifier 65 coupled electrically to the audio signal processor 63, and a service requesting unit 66 coupled electrically to the microprocessor 64. The main functions of the control box 5 are to amplify the impedance-matched signal from the distributor 5, and to process the impedance-matched signal for channel selection, volume and tone control, noise reduction, etc.

Each control panel 7 is coupled electrically to a respective control box 6 and receives the output of the latter. In this embodiment, each control panel 7 includes a first panel 71 to be positioned on a window seat of the vehicle, and a second panel 72 to be positioned on an aisle seat of the vehicle. The first and second panels 71, 72 are provided with channel select keys, volume control keys, a service paging key coupled electrically to the microprocessor 64 of the respective control box 6, a mute key, an LED power indicator, an earphone socket, a channel indicator, etc. (not shown herein). The control panels 7 are thus manually operable by passengers for providing various control signals, including channel selection, volume and tone control signals, to the microprocessor 64 of the respective control box 6.

Each sound reproducing unit 8, e.g., an earphone, is plugged into the earphone socket of a respective control panel 7 for audio reproduction.

The service paging unit 9 is coupled electrically to the distributor 6, and has visual indications corresponding in number to the passenger seats. When the aforesaid service paging key of the control panel 7 is operated, the microprocessor 64 of the respective control box 6 enables the service requesting unit 66 to transmit a service request to the service paging unit 9 through the distributor 5. The service paging unit 9 subsequently outputs a visible service indicator signal in response to the service request to indicate the corresponding passenger seat from which the service request originated.

During operation, the audio-visual signals from the signal sources 41, 42, 43, 44 are processed by the distributor 5, i.e., amplification and impedance matching. When the control box 6 receives the impedance-matched signal from the distributor 5, the voltage protecting circuit 61 and the voltage damper 62 therein will respectively prevent damage due to a reverse polarity input from the distributor 5 and block voltage surge from reaching the audio signal processor 63. The impedance-matched signal will be processed by the audio signal processor 63, such as channel selection, volume and tone control, etc., according to the control signal received by the microprocessor 64 from the respective control panel 7. The processed output of the audio signal processor 63 is then amplified by the post-amplifier 65, and provided to the respective control panel 7 for subsequent reproduction by the respective sound reproducing unit 8. Moreover, when the service paging key of the control panel 7 is operated, the microprocessor 64 of the respective control box 6 will enable the service requesting unit 66 to send a request signal to the service paging unit 9 through the impedance matching circuit 52 of the distributor 5 so that a visual indication of the corresponding passenger seat where the service request originated can be generated to alert service personnel.

As compared to the conventional audio-visual systems described in the foregoing, the audio-visual system 3 of this invention uses impedance matching techniques to preserve the integrity of source audio signals and to minimize the effects of attenuation, distortion and noise without using A/D and D/A converters that would result in a substantial increase in manufacturing cost. Moreover, the inclusion of the service paging function in the audio-visual system 3 allows service personnel to provide timely and quiet service to passengers and dispenses with the need for passengers to walk to or yell at the service personnel when assistance is required.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An audio-visual system for vehicle use, comprising:
a signal source that provides at least an audio source signal;
a distributor including a pre-amplifier coupled electrically to said signal source for amplifying the audio source signal therefrom, and an impedance matching circuit coupled electrically to said pre-amplifier for matching load impedance associated with an amplified audio source signal from said pre-amplifier to that of said signal source;
a control box coupled electrically to said distributor for processing and amplifying an impedance-matched signal received therefrom;
a control panel coupled electrically to said control box for receiving output of said control box; and
a sound reproducing unit coupled electrically to said control panel for audio reproduction.

2. The audio-visual system as claimed in claim 1, wherein said control panel is manually operable so as to generate at least one of volume and tone control signals provided to said control box.

3. The audio-visual system as claimed in claim 2, wherein said control box includes:
an audio signal processor coupled electrically to said distributor;
a microprocessor coupled electrically to said audio signal processor and said control panel, said microprocessor controlling said audio signal processor in response to the control signal received from said control panel for processing the impedance-matched signal received from said distributor accordingly; and
an amplifier coupled electrically to said audio signal processor and said control panel.

4. The audio-visual system as claimed in claim 3, wherein said control box further includes a voltage protecting circuit coupled electrically between said distributor and said audio signal processor for preventing damage due to a reverse polarity input from said distributor.

5. The audio-visual system as claimed in claim 4, wherein said control box further includes a voltage damper coupled electrically between said voltage protecting circuit and said audio signal processor for blocking voltage surge.

6. The audio-visual system as claimed in claim 3, further comprising a service paging unit coupled electrically to said distributor, and a service requesting unit provided on said control box and coupled electrically to said microprocessor of said control box, said service requesting unit being enabled by said microprocessor to transmit a service request to said service paging unit through said distributor, said service paging unit outputting a service indicator signal in response to the service request.

7. The audio-visual system as claimed in claim 1, wherein said sound reproducing unit includes one of a speaker and an earphone.

8. An audio-visual system for vehicle use, comprising:
a plurality of signal sources, each of which provides at least an audio source signal;
a distributor including a plurality of pre-amplifiers, each of which is coupled electrically to a respective one of said signal sources for amplifying the audio source signal therefrom, said distributor further including an impedance matching circuit coupled electrically to said pre-amplifiers for matching load impedance associated with an amplified audio source signal from each of said pre-amplifiers to that of said signal sources;
a plurality of control boxes, each of which is coupled electrically to said distributor for processing and amplifying an impedance-matched signal received therefrom;
a plurality of control panels coupled electrically and respectively to said control boxes for receiving output of the respective one of said control boxes, each of said control panels being manually operable so as to generate at least one of channel selection, volume and tone control signals provided to the respective one of said control boxes; and
a plurality of sound reproducing units, each of which is coupled electrically to a respective one of said control panels for audio reproduction;
wherein each of said control boxes includes:
an audio signal processor coupled electrically to said distributor,
a microprocessor coupled electrically to said audio signal processor and the respective one of said control panels, said microprocessor controlling said audio signal processor in response to the control signal received from the respective one of said control panels for processing the impedance-matched signal received from said distributor accordingly, and
an amplifier coupled electrically to said audio signal processor and the respective one of said control panels.

9. The audio-visual system as claimed in claim 8, wherein each of said control boxes further includes a voltage protecting circuit coupled electrically between said distributor and said audio signal processor for preventing damage due to a reverse polarity input from said distributor.

10. The audio-visual system as claimed in claim 9, wherein each of said control boxes further includes a voltage damper coupled electrically between said voltage protecting circuit and said audio signal processor for blocking voltage surge.

11. The audio-visual system as claimed in claim 8, further comprising a service paging unit coupled electrically to said distributor, and a plurality of service requesting units, each of which is provided on a respective one of said control boxes and is coupled electrically to said microprocessor of the respective one of said control boxes, each of said service requesting units being enabled by said microprocessor of the respective one of said control boxes to transmit a service request to said service paging unit through said distributor, said service paging unit outputting a service indicator signal in response to the service request.
